(19) United States
(12) Patent Application Publication
(10) Pub. No.: US 2011/0150729 A1
(43) Pub. Date: Jun. 23, 2011

(54) Process for Heap Leaching of Nickeliferous Oxidic Ores

(76) Inventor: Houyuan Liu, Henderson, NV (US)

(21) Appl. No.: 13/000,493

(22) PCT Filed: Jul. 2, 2009
(86) PCT No.: PCT/AU2009/000855

§ 371 Date: Feb. 8, 2011

(30) Foreign Application Priority Data
Jul. 2, 2008 (AU) 2008903400

(51) Int. Cl. C01G 53/00; C01G 51/00; C01G 53/11; C01G 53/04; C01G 51/04; C01G 53/06; C01G 51/06

(52) U.S. Cl. 423/139; 423/150.1; 423/140

(57) ABSTRACT

A process for the recovery of nickel and cobalt from a nickeliferous oxidic ore by heap leaching and/or atmospheric agitation leaching, the process including the steps of: mixing a sulfur containing reductant selected from reductants that do not include copper into a nickeliferous oxidic ore; leaching the reductant/ore mixture with an acidic leach reagent to produce a pregnant leach solution including nickel, cobalt, iron substantially in a ferrous form and other acid soluble impurities; and recovering the nickel and cobalt from the pregnant leach solution.

### FIELD OF THE INVENTION

The present invention generally relates to a new hydrometallurgical method of leaching nickeliferous oxidic type ores, to recover nickel and cobalt values. In particular, in one embodiment the present invention provides a method of extraction of nickel and cobalt from nickel and cobalt containing laterite ores by heap leaching and/or atmospheric agitation leaching of the ore with an acidic leach liquor addition together with the addition of a solid sulfur containing reductant such as pyrite.

### BACKGROUND OF THE INVENTION

The following discussion of the background to the invention is intended to facilitate an understanding of the invention. However, it should be appreciated that the discussion is not an acknowledgement or admission that any of the material referred to was published, known or part of the common general knowledge as at the priority date of the application.

Nickel and cobalt containing nickeliferous oxidic ore deposits, typically laterite ores, generally contain oxidic type ores, limonites, and silicate type ores, saprolites, in the same deposits. The state of the iron content in such laterite ore is normally ferric, namely Fe⁺³. The higher nickel content saprolites tend to be commercially treated by a pyrometallurgical process involving roasting and electrical smelting techniques to produce ferro nickel. The power requirements, specific silicon/magnesium/aluminium ratio for slag making a high iron to nickel ore ratio for the lower nickel content limonite and limonite/saprolite blends make this processing route too expensive and insufficient, and these ores are normally commercially treated by a combination of pyrometallurgical and hydrometallurgical processes, such as the Caron reduction roast-ammonium carbonate leach process.

In addition to conventional High Pressure Acidic Leach (HAPL) process to treat limonitic ore, other acid leaching techniques have been developed to exploit nickeliferous oxidic ore over the past decade. For example, Enhanced Pressure Acid Leach (EPAL) described in U.S. Pat. No. 6,379,636 in the name of BHP Minerals International Inc; and atmospheric agitation leaching described in U.S. Pat. No. 6,261,527 also in the name of BHP Minerals International Inc and Australian application 2003209829 in the name of QNI Technology Pty Ltd. In these processes the ferric ions in lateritic ore are dissolved by acid and then precipitated as hematite, jarosite, goethite, ferrihydrite and hydroxide under designed conditions. Each of these processes can be used to explore and treat the whole lateritic ore body, i.e. both the limonite and the saprolite ore fractions.

In pressure acid leaching, the sulfuric acid leach reagent can be generated in situ within the ore through the addition of a sulfur containing compound under oxidation conditions. In U.S. Pat. No. 3,809,549 in the name of Opratko et al and Canadian Patent CA947089 in the name of The International Nickel Company of Canada Limited, pyrite is added to a nickel laterite feed prior to being fed into a pressure vessel. In the pressure vessel, the pyrite is oxidised with oxygen to ferric sulfate which hydrolyses to ferric hydroxide/ferric oxide and the leach reagent, sulfuric acid. The overall chemical reaction is exothermic, and therefore can be used to generate and maintain the temperature in the process vessel of between 200° C. to 300° C.

In atmospheric agitation leaching, a limonitic ore slurry is fed into an agitation vessel which is at atmospheric pressure. An acid leaching solution is introduced into the agitation vessel and the ore slurry is agitated in the vessel to promote mixing of the acid with the ore. The leached limonitic slurry is then mixed with a saprolite slurry in subsequent agitation vessels to leach the saprolite slurry and enable iron precipitation. The saprolite slurry is leached with the residual free acid in leached limonitic slurry and the acid released with iron precipitation. After solid/liquid separation, for example countercurrent decantation (CCD), the effluent liquor, termed the pregnant leach solution (PLS) is passed to downstream unit operation where the metal values are recovered.

Heap leaching is yet another recovery process that has been developed to recover the nickel and cobalt content from a nickeliferous oxidic type ores. Examples of this process are described in for example U.S. Pat. Nos. 5,571,308 and 6,312,500, both in the name of BHP Minerals International Inc. Heap leaching involves piling raw ore directly from ore deposits into heaps that vary in height. An acid leaching solution is introduced on to the top of the heap to percolate down through the heap. The PLS is drained from the base of the heap and passes to a processing plant where the metal values are recovered.

Due to the high Fe/Ni concentration ratio in lateritic type ores, the PLS produced from an atmospheric leach process and a heap leach of a lateritic ore contains a significant amount of iron predominantly in the ferric form. The presence of ferric iron is undesirable in the Ni/Co recovery circuit and in most cases is removed by purification or precipitation, generally as goethite, hematite, jarosite, ferrihydrite or a hydroxide before recovery of the nickel and/or cobalt. Precipitation is brought about by raising the pH of the liquor by adding a suitable neutralizer. Purification can be achieved using Ion Exchange (IX) processes such as is disclosed in U.S. Pat. No. 6,350,420 B1 (BHP Minerals International Inc.), International patent publication WO 00/053820 (BHP Minerals International Inc.) and WO2006/029443 (BHP Billiton SSM Technology Ltd.). In ion exchange processes nickel and cobalt is extracted from the PLS, leaving the major impurities in the raffinate.

The PLS treated using these processes is based on the assumption that the iron from the laterite ore is present in the ferric form (Fe⁺³), allowing the iron content of the PLS to be precipitated as hematite, goethite, jarosite, ferrihydrite or hydroxide. Downstream nickel and cobalt recovery also focuses on Ni/Co separation from a Fe⁺³ containing PLS.

The present invention aims to provide an alternate atmospheric agitation leach and/or heap leach process in which a different pregnant leach solution composition is obtained where the iron content is predominantly in the ferrous state.

### SUMMARY OF THE INVENTION

It has been surprisingly found that a PLS including the iron content substantially in the ferrous form (Fe⁺²) provides advantageous processing for the recovery and separation of nickel and cobalt from iron and the other impurities in the PLS.

Accordingly, the present invention provides a process for the recovery of nickel and cobalt from a nickeliferous oxidic ore by heap leaching and/or atmospheric agitation leaching, the process including the steps of:
mixing a sulfur containing reductant selected from reductants that do not include copper into a nickeliferous oxidic ore;
leaching the reductant/ore mixture with an acidic leach reagent to produce a pregnant leach solution including nickel, cobalt, iron substantially in a ferrous form and other acid soluble impurities; and
recovering the nickel and cobalt from the pregnant leach solution.

The present invention therefore uses the addition of a sulfur containing reductant, such as pyrite, to a nickeliferous oxidic ore in a heap leaching and/or atmospheric agitation leach to convert the iron content of the ore and/or pregnant leach solution formed during the leaching step from the ferric form to the ferrous form.

In both heap leaching and atmospheric agitation leaching (also known as atmospheric leaching), an acidic leach reagent is used to leach the nickel, cobalt and iron content into a pregnant leach solution which is recovered from the process. When an acidic leach reagent such as sulphuric acid is used, the general leaching reactions for the limonite and saprolite fractions of the nickeliferous oxidic ore are as follows:

Acid Leach of Limonite in which Goethite is the Major Ni-Containing Mineral:

(Fe, Ni)OOH+H₂SO₄→Ni⁺²+Fe⁺³+SO₄⁻²+H₂O (1)

Acid Leach of Saprolite in which Serpentine is the Major Ni-Containing Mineral:

(Ni, Mg)₃Si₂O₅(OH)₄+H₂SO₄→Ni⁺²+Mg⁺²+SO₄⁻²+SiO₂+H₂O (2)

While not wishing to be limited to any one theory, it is thought the addition of a sulfur containing reductant can instigate an additional reaction where the ferric iron content is converted to the ferrous iron form. In the case of the sulfur containing reductant being pyrite, at least one of the following reactions (3) and (4) occurs in addition to reactions (1) and/or (2):

### Oxidation of Pyrite to Produce Acid and Convert Fe⁺³ to Fe⁺²:

FeS₂+14Fe⁺³+8H₂O→15Fe⁺²+2SO₄⁻²+16H⁺ (3)

Pyrite Conversion of Fe⁺³ to Fe⁺² without Acid Production:

FeS₂+2Fe⁺³=3Fe⁺²+2S⁰ (4)

Reaction 3 is an exothermic reaction. Accordingly, both heat and acid are released during pyrite oxidation which can benefit the leaching process (either heap or atmospheric agitation leaching) through the generation of higher leaching temperatures from the generated reaction heat and lower acid consumption due to the in situ production of acid from the reaction. The conversion from ferric form to ferrous form (Fe⁺²) following this reaction can therefore reduce the consumption of an acidic leach reagent that is added to a heap leach and/or atmospheric agitation leach process. The weight stoichiometric ratio between pyrite and ferric ions is 0.15:1.

In reaction 4, the sulfur in pyrite is oxidized to elementary sulfur by ferric ions. The equation 4 is also an exothermic reaction. However, no acid is released in this reaction. The weight stoichiometric ratio between pyrite and ferric ions is 1.07:1. Accordingly, the above reaction (4) has kinetics that strongly favours the formation of ferrous iron and sulfur and is exothermic resulting in the heap being internally heated by this reaction.

The processes of the present invention is applicable for leaching any type of nickeliferous oxidic ore including nickel and cobalt bearing laterite and sulfide ores. In one embodiment, the process of the present invention is used to process nickeliferous oxidic ore that is substantially laterite.

The processes of the present invention forms part of an overall process for the recovery of nickel and cobalt in which an amount of a sulfur containing reductant is added to the nickeliferous oxidic ore to substantially convert the ferric iron (Fe⁺³) content of the ore and/or of a leach solution produced through the addition of a leach reagent to the ore to ferrous iron (Fe⁺²). Any suitable sulfur containing reductant can be used, depending on the specification of downstream recovery. Copper containing reductants such as copper sulphide are specifically excluded because the dissolved copper ions are detrimental to some downstream processes. For example, in ion exchange, some resins are predominantly loaded by copper ions because copper ions have the highest affinity in these resins as compared to Ni and Co. In a preferred embodiment, the sulfur containing reductant is pyrite.

It is known that PLS from conventional heap leaching and/or atmospheric agitation leach with lateritic ore processes have a ferric iron (Fe⁺³) content of about 20-120 g/L. It is preferable for the amount of the sulfur containing reductant mixed into the nickeliferous oxidic ore is at least sufficient to convert all of the ferric iron content of the nickeliferous oxidic ore and/or pregnant leach solution to the ferrous form of iron. When the sulfur containing reductant is pyrite, the pyrite is added to the nickeliferous oxidic ore in a ratio of the pyrite to the ferric ion (to be leached from the ore) of between 0.1:1 and 2:1 and more preferably between 0.15:1 (in accordance with the weight stoichiometric ratio in Eq. 3) and 1.07:1 (in accordance with the weight stoichiometric ratio in Eq. 4).

The substantial conversion of the Fe⁺³ content to Fe⁺² provides a PLS containing Fe⁺² that allows for a different or modified downstream Ni/Co recovery strategy to be used. The acid released with this conversion can leach more laterite to decrease the overall acid consumption. In this respect, the nickel and cobalt may be recovered from this type of PLS by conventional methods such as precipitation as mixed sulfide, mixed hydroxide or carbonate treatment, by solvent extraction, by ion exchange processes, or other known metallurgical processing routes to extract and separate the nickel and cobalt from Fe⁺² containing media. However, the presence of Fe⁺² in the PLS enables these processes to be optimised to exploit the differences between Fe⁺³ containing PLS and Fe⁺² containing PLS.

For example, when using ion exchange (IX) techniques including an ion exchange resin such as Dowex M4195 with the function group of bispicolylamine, the selectivity of this resin to load nickel should increase because the affinity of the resin for Ni and Co is much greater than Fe⁺². This difference in affinity is much greater than the equivalent Ni/Co—Fe⁺³ system in which resins tend to retain both Ni and a portion of the Fe⁺³ content of the PLS. The conversion of ferric iron content in the PLS to the ferrous form of iron therefore increases the effective capacity of resin and enables the resin to more selectively separate nickel from the iron in PLS, thereby reducing the size of an IX device and the downstream equipment. Advantageously, other ion exchange resins with the function group of iminodiacetic acid, such as Amberite IRC 748, Bayer TP 207 and Purolite SR 930, which have the highest affinity to ferric ion Fe⁺³, could also be used to recover nickel and cobalt without the pre-neutralization of Fe⁺³ due to their higher Ni⁺² affinity than Fe⁺². The ion exchange devices used are either fixed bed columns or fluidization bed equipment for example Resin In Pulp technology (RIP).

The pH of the PLS can effect the selective absorption of nickel ions from the PLS when in contact with a particular ion exchange resin. For Dow M4195, it is preferable for the PLS to have a pH of from about 1.0 to 2.5. With Amberite IRC 748, Bayer TP 207 and Purolite SR 930 it is preferable for the PLS to have a pH of from about 2.0 to 4.5. Within these pH ranges the respective ion exchange resin selectively absorbs nickel in preference to cobalt and ferrous ion and any acid soluble impurities such as manganese, chromium, magnesium and aluminium that may be present.

The cobalt may also be recovered by separate ion exchange processing wherein the raffinate, which by now is substantially free of nickel and ferric iron ions, is contacted with an ion exchange resin.

Similarly, modified or new solvent extraction (SX) systems (as compared to traditional SX systems) can be used and/or developed to extract Ni⁺² and Co⁺² from a Fe⁺² containing PLS.

The conversion from ferric to ferrous form of iron in the present invention also decreases the nickel and cobalt loss caused by co-precipitation with ferric ions in conventional nickel recovery using SX or IX processes in those embodiments that include a pre-neutralization step to precipitate ferric ions.

In heap leaching and atmospheric agitation leaching, the reductant/ore mixture is leached with an acidic leach reagent which contacts the ore to produce a product liquor solution containing at least nickel, cobalt, iron and acid soluble impurities. In some embodiments, at least part of the acid leach reagent is provided through the addition of a sulfuric or a hydrochloric acid solution to the ore heap in the leaching step. Preferably, the acid solution is sulfuric acid.

In some embodiments, the sulfur containing reductant can also supplement, or in some cases substantially replace the addition of an acidic leach reagent solution for the leaching step. In this respect, the sulfur containing reductant can decrease the overall acid consumption of a heap leach and/or an atmospheric agitation leach process in the leaching process. In these embodiments, at least part of the acid leach reagent is generated in situ from the sulfur containing reductant content of the ore heap in the leaching step. In this respect, some of the sulfur containing reductant content can be oxidised to sulfuric acid. When using pyrite, this in situ acid leach reagent generation process can follow reaction (3). The overall reaction is exothermic, thereby resulting in the heap also being internally heated by this reaction.

In those embodiments of the invention in which the leaching process is an atmospheric agitation leaching process, it is preferred the process includes the step of:
feeding the ore/reductant mixture into at least one agitation vessel prior to the leaching step.

In an atmospheric agitation leaching process, it is preferred that the process further includes the step of separating the limonite and saprolite ore fraction of the nickeliferous oxidic type ores. It should be appreciated that the term limonite refers to the high iron (at least 25 wt. % Fe) and low magnesium (0.5 to 6 wt. % Mg) fraction contained within nickeliferous laterite ores. Similarly, the term saprolite denotes the low iron (5-20 wt % Fe) and high magnesium (at least 8 wt. % Mg) fraction contained within nickeliferous laterite ores. It is to be understood however that these composition ranges are in no way limiting, and represent ranges which are advantageous for an atmospheric agitation leaching process in accordance with the present invention. In some embodiments, the ores may be separated, preferably classified by pulping and/or screening. Alternatively, each ore fraction could be mined selectively as to end up with two distinctive limonite and saprolite ore compositions.

In those embodiments in which the limonite and saprolite ore fraction have been separated, it is preferable the process of the present invention includes the following steps:
mixing a sulfur containing reductant into the limonite ore fraction of the nickeliferous oxidic ore;
leaching the limonite ore/reductant mixture with an acidic leach reagent to produce an intermediate product slurry;
adding the intermediate product slurry to the saprolite ore fraction to leach the saprolite ore fraction thereby producing a pregnant leach solution including nickel, cobalt, iron substantially in a ferrous form and other acid soluble impurities; and
recovering the nickel and cobalt from the pregnant leach solution.

In some embodiments, the process further includes the step of:
mixing a sulfur containing reductant into the saprolite ore fraction of the nickeliferous oxidic ore prior to adding the intermediate product slurry to this ore fraction.

The leaching steps of each ore fraction are preferably conducted in an agitation vessel to promote mixing and contact between the leach reagent/intermediate product slurry and the relevant ore fraction. In each case, the leached ferric iron content of the limonite ore fraction and saprolite ore fraction respectively is substantially converted to ferrous ions through reaction with the sulfur containing reductant.

In some embodiments, the process further includes the step of:
pulping at least one of the limonite or saprolite ore fraction with at least one of water, seawater or a hypersaline solution.

In those embodiments of the invention in which the leaching process is a heap leaching process, it is preferred the process includes the step of forming the ore/pyrite mixture into at least one heap prior to the leaching step. In this respect, the product PLS is produced by establishing at least one ore heap and then establishing (through the addition of an acid leach solution and/or generating in situ) an acidic leach reagent that can percolate through the heap to produce a product liquor stream containing at least nickel, cobalt, iron and other acid soluble impurities.

In some embodiments, the heap leach process is established in a counter current system wherein at least two ore heaps are formed and arranged as a primary and secondary heap. In these embodiments, the process including the steps of:
leaching the secondary heap using the acidic leach reagent to produce an intermediate product liquor; and
adding the intermediate product liquor to the primary heap to leach the primary heap in a counter current process, and producing a nickel and cobalt rich pregnant leach solution. The PLS generally has a low acidity which benefits the lower neutralizer consumption in downstream.

In these embodiments, it is preferred for the secondary heap to be discarded once it is depleted of nickel, and for the primary heap to become a new secondary heap, and a new ore heap to be formed to become a new primary heap.

The nickeliferous oxidic ore is preferably pre-treated or preconditioned to a state which is suitable for the heap leaching process. In some embodiments, at least a portion of the ore material of the mixing step is crushed and agglomerated using water, aqueous sulfuric acid or binding materials prior to forming the ore heap. The crushing and agglomeration processes are undertaken to improve permeability of the ore heap. Preferably, the ore is crushed to a size of less than 25 mm.

The PLS from either the heap leaching or atmospheric agitation leaching embodiments of the invention can be further treated prior to Co/Ni extraction processes to condition the PLS to a state suitable for the extraction processes. In some embodiments, the process of the present invention further includes the step of neutralizing the pregnant leach solution through the addition of a neutralizing agent selected from limestone, lime, calcrete or a combination thereof to the PLS to precipitate impurities including at least one of iron, aluminium, magnesium or manganese. The step of neutralizing the pregnant leach solution is preferably conducted prior to the PLS being directed to a metals recovery circuit.

### DETAILED DESCRIPTION

The present invention relates to an improved hydrometallurgical method for the extraction of nickel from nickeliferous oxidic ore. In general terms, the method utilises the addition of a sulfur containing reductant such as pyrite to a nickeliferous oxidic ore so that the leached ferric content of the ore can be converted to ferrous ions form during leaching. The presence of ferrous ions as opposed to ferric ions in the PLS provides advantages in subsequent nickel and cobalt metal recovery processes.

In a first embodiment of the process of the present invention, the leaching step is conducted using a heap leaching process. In this heap leach process, a laterite ore material feed is passed to a crushing step in which the laterite ore is crushed to a size less than 25 mm. The ore then proceeds as crushed ore through an agglomeration circuit in which agglomeration is achieved with aqueous sulfuric acid or any acidic liquor produced from a downstream process such as an ion exchange or solvent extraction raffinate. Agglomeration is undertaken to improve the permeability of a heap which is subsequently formed using the agglomerated ore. The total acid addition during agglomeration is within the range of about 0 to 150 kg of acid per tonne.

Pyrite is mixed with laterite ore during agglomeration in a ratio of pyrite to laterite ore calculated on that basis of the amount of ferric ions to be converted to ferrous ions in PLS. The preferred ratio of pyrite to the converted ferric ions in PLS is between 0.15 to 1 to 1.07:1. Mixing of the pyrite and laterite ore could be achieved in a rotary mixer, a screw mixer or similar process mixing equipment.

The agglomerated ore/pyrite mixture is subsequently deposited in a heap or heaps. This mixture can be arranged into a single heap but is more preferably arranged in at least two heaps, a primary and a secondary heap, to be operated as a counter current heap leach system. The counter current heap leach process has the advantage of lower acid consumption and has a cleaner product solution than a single heap system.

The leaching process of the ore is initiated by percolating a sulfuric acid and water leaching agent through the secondary heap. The leaching agent is irrigated through the heap at a rate within the range of 1 and 60 L/m²/hr. This produces an intermediate PLS which exits the bottom of the secondary heap. The leaching agent has an equivalent acid concentration within the range of about 10 and 150 g/L. In some cases, the pyrite content of the heap can be used to supplement the sulfuric acid leaching agent. In this respect, at least some of the pyrite content is oxidised to sulfuric acid and iron oxide/iron hydroxide within the heap. The overall reaction is exothermic, thereby being internally heating the heap.

The pyrite is primarily added to the nickeliferous oxidic ore to convert the ferric iron (Fe⁺³) content of the ore and/or the PLS produced in the leaching process to ferrous iron (Fe⁺²) in accordance with reaction (3) and/or (4). Heat is also generated through reaction (3) and/or (4) occurring between the pyrite and the ferric iron content of the ore and/or PLS that is generated within the ore heap during the leaching process. The reaction (3) and/or (4) is exothermic thereby providing another internal heating source for the respective ore heap.

The intermediate PLS is then added to the primary heap leach in a counter current process. This produces a nickel and cobalt rich product PLS with low acidity, which also contains iron and a number of other impurities. Again, in some cases the pyrite content of the primary heap can also supplement the leaching effect of the intermediate PLS. When the secondary heap is depleted of nickel, the contents of this heap are discarded. The primary heap is then used as a new secondary heap, and a new ore heap including the agglomerated ore and pyrite mixture is formed for use as a new primary heap.

The product PLS produced from the primary heap includes nickel, cobalt, iron substantially in a ferrous form and other acid soluble impurities. The presence of iron substantially in a ferrous form (as opposed to ferric form as is produced by other heap leaching processes) provides advantageous and/or alternative downstream processing for the recovery and separation of nickel and cobalt from iron and the other impurities in the PLS as compared to traditional downstream treatment methods.

In a second embodiment of the process of the present invention, the leaching step is conducted using an atmospheric agitation leaching process. In this atmospheric agitation leaching process, limonite and saprolite ore fractions of a nickeliferous oxidic ore are first separated or classified. In some embodiments, the limonite and saprolite ore fractions may be classified by pulping and screening. In other embodiments, the limonite and saprolite ore fractions may be mined selectively as to end up with two distinctive ore compositions.

The limonite ore fraction generally has a high iron content (>25 wt %) substantially in ferric form. Accordingly, pyrite is mixed with limonite ore in a calculated ratio of between 0.15:1 to 1.07:1 of pyrite to the to-be-leached ferric ions from limonite ore. This ratio is preferably calculated on that basis of the amount of ferric ions to be converted to ferrous ions in the PLS. Mixing of the pyrite and limonite ore could be achieved in a rotary mixer, a screw mixer or similar process mixing equipment. The limonite/pyrite mixture is thereafter pulped with water, seawater, or hypersaline liquor to a solids concentration of about 25% and then added to an agitated vessel. Sulfuric acid is added to the mixture in the vessel at a temperature below the boiling point of the pulp at atmospheric pressure while maintaining the redox potential below 1000 mV versus standard hydrogen electrode (“SHE”). The pulp is agitated (for example by stirring) in the vessel for a period of time at the specified temperature to substantially effect the dissolution of nickel, cobalt and iron from the ore. This leaching process produces an intermediate product slurry which is rich with nickel and cobalt, contains an iron content substantially in a ferrous form, other acid soluble impurities and a residual content of acid.

The pyrite is primarily added to the limonite ore to convert the ferric iron (Fe⁺³) content of the ore and/or the intermediate product slurry produced in the leaching process to ferrous iron (Fe⁺²) in accordance with reaction (3) and/or (4). Again, heat is also generated through reaction (3) and/or (4) occurring between the pyrite and the ferric iron content. The reaction (3) and/or (4) is exothermic thereby providing another internal heating source for the leach mixture.

The intermediate product slurry can be then added to the saprolite ore fraction to leach the saprolite ore fraction. In this respect, the saprolite ore fraction is pulped with water, seawater, or hypersaline liquor to a solids concentration of about 25% and then added to an agitated vessel. The intermediate product slurry is also added to the agitated vessel. The mixture of intermediate product slurry and saprolite ore pulp is then agitated (for example by stirring) in the vessel for a period of time at the temperature between 80° C. to boiling point at atmospheric pressure to significantly effect the dissolution of nickel, cobalt and iron from the ore. A product slurry is extracted from the vessel after the product slurry is passed through a solid/liquid separation step to produce a product PLS rich with nickel and cobalt and containing an iron content substantially in a ferrous form and other acid soluble impurities.

While the saprolite ore fraction has a low iron content, it may still be desirable in some embodiments to mix the saprolite ore fraction with pyrite prior to or during the pulping step to ensure that any ferric iron content of the saprolite ore fraction is converted to the ferrous form. Similarly, additional leach acid may be added where necessary for effective leaching of the Ni/Co content of the saprolite ore.

The product PLS produced from this atmospheric agitation leaching process includes nickel, cobalt, iron substantially in a ferrous form and other acid soluble impurities. Again, the presence of iron substantially in a ferrous form (as opposed to ferric form as is produced by other atmospheric agitation leaching processes) provides advantageous and/or alternative downstream processing for the removal of iron and the other impurities in the PLS as compared to traditional downstream treatment methods.

Following the leaching steps of the above described heap leaching process or the above described atmospheric agitation leaching process, the nickel and cobalt may be recovered from the product PLS by conventional methods such as precipitation as a mixed sulfide, mixed hydroxide or carbonate treatment, by solvent extraction, by ion exchange processes, or other known metallurgical processing routes to extract and separate the nickel and cobalt.

In some embodiments, the product PLS from the heap leaching process and/or the atmospheric leach process can also passed through a neutralization stage in which the product PLS is neutralized through the addition of a neutralizing agent such as limestone, or lime to precipitate impurities including at least one of iron, aluminium, magnesium or manganese prior to the product PLS being directed to a metals recovery circuit.

In one embodiment, the product PLS is treated by an ion exchange step, where the majority of the nickel is retained on the resin bed and the major portion of the cobalt, ferrous iron content, and other impurities remain in the raffinate solution and pass through the ion exchange. The resin is preferably is a resin with a bis-picolylamine functional group such as Dowex M4195. Other suitable resins include Amberite 748, Purolite SR 930 and Bayer TP207 due to their higher Ni⁺² affinity compared to Fe⁺². For Dowex M4195, at pH 2 the absorption constants indicating selectivity of the resin are in the order is Ni⁺²>Fe⁺³>Co⁺>Fe⁺²>Mn⁺²>Mg⁺²>Al⁺³. Therefore, a Dowex M4195 resin can recover nickel at a pH of from about 1.0 to 2.5 while the cobalt, ferrous iron and acid soluble impurity contents remain in the raffinate. The retained nickel is eluted from the resin using sulfuric acid solution to produce an eluate containing nickel. Some of this eluate and some water may be recycled and added to the sulfuric acid as part of the eluting process.

As can be appreciated, other heap leaching and atmospheric agitation leaching processes retain the ferric iron content in the PLS. Accordingly, a portion of the ferric iron (Fe⁺³) content is retained in the resin with the nickel content during ion exchange steps on this type of PLS. The presence of Fe⁺³ necessitates the removal of the ferric iron content from the eluted solution at some point downstream in these other processes. The conversion of ferric iron in the PLS to ferrous iron in the process of the present invention enables the resin of an ion exchange process to more selectively separate nickel from the PLS with higher effective capacity, thereby reducing the size of the downstream equipment.

The ion exchange eluate containing the nickel can be neutralized, preferably with magnesium oxide, soda ash or acoustic soda, to precipitate a nickel hydroxide product which is subjected to solid/liquid separation, filtered and dried. Optionally, the nickel hydroxide product may then be reduced, and fed to an electric arc furnace for smelting and cast to produce a cast nickel product or be an intermediate product for production of nickel cathode.

In order to dispose of the ferrous iron content of the raffinate from the nickel ion exchange step, the iron content may be partially neutralized, such as by using calcium oxide, to precipitate the majority of the iron for disposal.

The cobalt can be recovered from the partially neutralized raffinate, which is now mostly depleted of nickel, using a cobalt ion exchange step. In this step, the cobalt is extracted onto the resin leaving a cobalt depleted raffinate which contains ferrous ions and other impurities. The cobalt ion exchange resin may again be a resin with a bis-picolylamine functional group, such as Dowex M4195. The cobalt content can be recovered from the eluate either as a mixed cobalt/nickel hydroxide precipitate (MHP) by neutralization with, for example magnesium oxide, or as a mixed cobalt/nickel sulfide precipitate (MSP) by sulfidation with, for example a sodium sulfide solution or sodium bi-sulfide solution or hydrogen sulphide gas.

An advantage of the process described is that the heat release inside the ore/pyrite mixture from the pyrite conversion reactions accelerates the leaching kinetics during leaching as compared to other heap leaching processes and atmospheric agitation leaching processes.

A further advantage of the process described is that, as a consequence of the conversion of the ferric ion to ferrous ion, alternate downstream Ni/Co recovery processes as compared to other heap leaching processes and atmospheric agitation leaching processes are now possible after using the above described.

A further advantage of the process described is that the acid released as a consequence of the conversion of the ferric ion to ferrous ion helps to decrease overall acid consumption.

Yet a further advantage of the process described is that, the resulting product PLS provides improved nickel effective capacity and selectivity compared to Fe⁺² when using ion exchange processes.

The process of the present invention has a further advantage over other heap leaching processes and atmospheric agitation leaching processes, in that when using a neutralizer, for example lime or limestone, the process of the present invention has a reduced consumption of neutralizer. In some embodiments, it has been found that when using Fe⁺² containing PLS the consumption of neutralizer is two thirds that of a Fe⁺³ containing PLS.

Those skilled in the art will appreciate that the invention described herein is susceptible to variations and modifications other than those specifically described. It is understood that the invention includes all such variations and modifications which fall within the spirit and scope of the present invention.

Throughout the description and claims of the specification the word “comprise” and variations of the word, such as “comprising” and “comprises”, is not intended to exclude other additives, components, integers or steps.

1-20. (canceled)

21. A process for the recovery of nickel and cobalt from a nickeliferous oxidic ore by heap leaching and/or atmospheric agitation leaching, the process including the steps of:
mixing a sulfur containing reductant into a nickeliferous oxidic ore where the reductant is selected from reductants that do not include copper;
leaching the reductant/ore mixture with an acidic leach reagent to produce a pregnant leach solution including nickel, cobalt, iron substantially in a ferrous form and other acid soluble impurities; and
recovering the nickel and cobalt from the pregnant leach solution.

22. A process according to claim 21, in which the sulfur containing reductant is pyrite.

23. A process according to claim 21, wherein the amount of the sulfur containing reductant mixed into the nickeliferous oxidic ore is at least sufficient to convert all of the leached ferric ions from nickeliferous oxidic ore and/or pregnant leach solution to the ferrous ions.

24. A process according to claim 22, wherein pyrite is added to the nickeliferous oxidic ore in a ratio of pyrite to ferric ions to be leached from the ore of between about 0.1:1 and about 2:1.

25. A process according to claim 21, wherein the nickel and the cobalt is recovered from the pregnant leach solution by precipitation as a sulfide, hydroxide or carbonate; by solvent extraction; or by an ion exchange process.

26. A process according to claim 25, wherein the ion exchange process uses ion exchange resin selected from at least one of Dowex M4195, Amberlite IRC 748, Bayer TP207 or Purolite SR 930.

27. A process according to claim 26 wherein the pregnant leach solution containing the nickel, cobalt, ferrous ions and other acid soluble impurities has a pH of from about 1.0 to about 2.5 for selective absorption of nickel ions when in contact with Dow M4195 ion exchange resin, or has a pH of from about 2.0 to about 4.5 for selective absorption of nickel ions when in contact with Amberlite IRC 748, Bayer TP 207 or Purolite SR 930.

28. A process according to claim 21 wherein the nickeliferous oxidic ore is substantially laterite.

29. A process according to claim 21 wherein the leaching process is an atmospheric agitation leaching process in which the reductant/ore mixture is fed into at least one agitation vessel prior to the leaching step.

30. A process according to claim 29, further including the step of separating the nickeliferous oxidic ore into at least a limonite and a saprolite ore fraction.

31. A process according to claim 30, further including the steps of:
mixing a sulfur containing reductant into the limonite ore fraction of the nickeliferous oxidic ore to form a reductant/limonite ore mixture;
leaching the reductant/limonite ore mixture with an acidic leach reagent to produce an intermediate product slurry;
adding the intermediate product slurry to a saprolite ore slurry to leach the saprolite ore fraction thereby producing a product pregnant leach solution including nickel, cobalt, iron substantially in a ferrous form and other acid soluble impurities; and
recovering the nickel and cobalt from the pregnant leach solution.

32. A process according to claim 31, further including the step of:
mixing a sulfur containing reductant into the saprolite ore fraction of the nickeliferous oxidic ore prior to adding the intermediate product slurry to the saprolite ore slurry.

33. A process according to claim 30, further including the step of:
pulping at least one of the limonite or saprolite ore fraction with at least one of water, seawater or a hypersaline solution.

34. A process according to claim 21 wherein the leaching process is a heap leaching process in which the reductant/ore mixture is formed into at least one heap prior to the leaching step.

35. A process according to claim 34, wherein at least two ore heaps are formed and arranged as a primary and secondary heap, the process including the steps of:
leaching the secondary heap using the acidic leach reagent to produce an intermediate product liquor; and
adding the intermediate product liquor to the primary heap to leach the primary heap in a counter current process, and producing a nickel and cobalt rich pregnant leach solution.

36. A process according to claim 35, wherein when the secondary heap is depleted of nickel, it is discarded and the primary heap becomes the secondary heap, and a new ore heap is formed and becomes the primary heap.

37. A process according to claim 34 wherein at least a portion of the ore material is crushed and agglomerated using water, aqueous sulfuric acid or other binding materials prior to forming the ore heap to improve permeability of the ore heap.

38. A process according to claim 21 wherein in the leaching step at least part of the acid leach reagent is provided through the addition of sulfuric or hydrochloric acid solution to the ore heap.

39. A process according to claim 21 wherein in the leaching step at least part of the acid leach reagent is generated in situ from the sulfur containing reductant content mixed with the ore.

40. A process according to claim 21 further including the step of neutralizing the pregnant leach solution prior to recovering the nickel and cobalt through the addition of a neutralizing agent selected from limestone, lime, calcrete, magnesia or a combination thereof to the pregnant leach solution to precipitate impurities including at least one of iron, aluminium, magnesium or manganese.
